(19) United States
(12) Patent Application Publication
(10) Pub. No.: US 2017/0312620 A1
(43) Pub. Date: Nov. 2, 2017

(54) Solid State Random Number Generator

(71) Applicant: Carl Rodson Allred, Colorado Springs, CO (US)

(72) Inventor: Carl Rodson Allred, Colorado Springs, CO (US)

(21) Appl. No.: 15/139,326

(22) Filed: Apr. 27, 2016

(51) Int. Cl. A63F 5/04; G07C 15/00; A44C 21/00

(52) U.S. Cl. CPC A63F 5/045; A44C 21/00; G07C 15/00

(57) ABSTRACT

Both dice and teetotums have been traditionally more portable than traditional spinning wheels as a means of random result generation. This invention aims to make a spinning wheel just as portable as either of the above.

### CROSS-REFERENCE TO RELATED APPLICATIONS

U.S. Patents

U.S. Pat. No. 1,271,551

U.S. Pat. No. 1,795,562 A

U.S. Pat. No. 5,150,900

U.S. Pat. No. 5,203,562

U.S. Pat. No. 5,938,197

U.S. Pat. No. 6,123,332 A

U.S. Pat. No. 6,318,720 B1

D303553

DE

DE411148

### STATEMENT REGARDING FEDERALLY SPONSORED RESEARCH/DEVELOPMENT

### Reference to Sequence Listing and a Table or Computer Program listing Compact Disc Appendix (if Applicable)

### BACKGROUND OF THE INVENTION

### Solid State Random Number Generator

This invention relates to apparatus for the determination of random numbers from a given set of integers, in particular, using a device without electronics other than a polyhedral die or a teetotum. A common problem in polyhedral dice is that the molding process by which the vast majority of dice are formed introduces imperfections into a traditional die or teetotum, which may lie undetected for various reasons.

There have been many attempts to deal with the problem of fair solid state random number generation over the years. These can be divided into three main camps. Dice, Teetotums, and Spinning Wheels.

Dice are by far the most favored means of solid state random number generation in common use. They are quite portable, easy to interpret, and have thousands of years of tradition in games behind them. Traditionally, they have the form of a polyhedron, such as a cube or an icosahedron. When thrown or rolled, the die comes to rest showing on its upper surface a random integer which varies depending on the type of die in play. There are also multiple different varieties of dice evidenced by most of the related patents cited.

Teetotums are a more recent invention, dating from Roman times. The original 1860's version of the Game of Life contained a teetotum so as to avoid the connotation of gambling. They can often be used in place of dice in most games, provided one has enough room to have them spin.

Spinning Wheels, or wheels of fortune have traditionally been reserved for larger, less portable random number applications, such as carnivals or roulette wheels.

### BRIEF SUMMARY OF THE INVENTION

The present invention is directed to a coin construction so that it replicates many of the probability features of a die without its physical limitations.

To achieve the advantages of the invention and in accordance with the purposes of the invention as embodied and broadly described herein, the invention comprises a coin's coin's construction. The coin construction includes having a disc of metal with stamped features on both sides. On the obverse side a set series of slots along with a variable artwork ornamentation is stamped. On the Reverse, a slightly raised central spinning point stands out from the back of the coin and other artwork or logos which may be present.

Preferably each of the slots on the obverse of the coin includes printed indicia thereon. For example this may take the form of numbers or other markings, such as specialized symbols used in a given game. The printed indicia indicate what result the user has generated.

In preferred arrangements, each of the slots is separated via a raised metal ridge, so as to catch a pointer being used upon the device.

It is to be understood that both the foregoing general description and the following detailed description are exemplary and explanatory only and are not restrictive of the invention as claimed. The accompanying drawings which are incorporated in and constitute a part of the specification, illustrate example embodiments of the invention and together with the description, serve to explain the principles of the invention.

### BRIEF DESCRIPTION OF THE SEVERAL VIEWS OF THE DRAWING

FIG. 1

An obverse view of the basic invention showing twenty slots

FIG. 2

A reverse view of the basic invention in all its forms

FIG. 3

A cross section view of the invention

FIG. 4

An obverse view showing proper operation of the invention

FIG. 5

An obverse view showing a variation of the indicia scheme from one to twenty

FIG. 6

An obverse view showing a variation of the indicia scheme from one to four

FIG. 7

An obverse view showing a variation of the indicia scheme from one to five

FIG. 8

An obverse view showing a variation of the indicia scheme from one to ten

FIG. 9

An obverse view of the basic invention showing twenty-four slots

FIG. 10

An obverse view showing a variation of the indicia scheme from one to twenty-four

FIG. 11

An obverse view showing a variation of the indicia scheme from one to twelve

FIG. 12

an obverse view showing a variation of the indicia scheme from one to eight

FIG. 13

An obverse view showing a variation of the indicia scheme from one to six

FIG. 14

An obverse view showing a variation of the indicia scheme from one to four

FIG. 15

An obverse view showing a variation of the indicia scheme from one to three

FIG. 16

An obverse view of the basic invention showing 100 slots

### DETAILED DESCRIPTION OF THE INVENTION

Reference will now be made in detail to the present preferred embodiments of the invention, examples of which are illustrated in the accompanying drawings.

To achieve the advantages of the invention, and in accordance with the purposes of the invention, as embodied and broadly described herein, the invention comprises a coin construction. As embodied herein, a first embodiment of a coin construction is shown generally in FIGS. 1-8 at 20. Coin 20 includes an obverse side with indented slots and reverse side with a spinning point which extends beyond the flat plain of a normal coin.

In reference to FIGS. 1 and 5-8, preferably, each of the slots is configured and arranged to display clear, readable indicia. In particular the shape of each of the slots is advantageous because of their ability to display large, legible indicia while also maintaining the ability to have artwork put onto the coin's surface. While a variety of working embodiments are contemplated, in the illustrated embodiments, the slots have a tapered appearance, and are not rectangular. In other words, each of the slots are bound by an outer and inner periphery, which consists of tapered slices, with an inner circle for artwork display.

Each of the slots, is identically shaped to every other slot, apart from possible stamped or die struck indicia.

In reference now to FIGS. 2-3 the spinning point is illustrated. Coin 20 is constructed such that the center of mass of the coin is centered over the precise center of the spinning point. By center of the spinning point, it is meant a point that is centered over the physical spinning point on the reverse side of the coin.

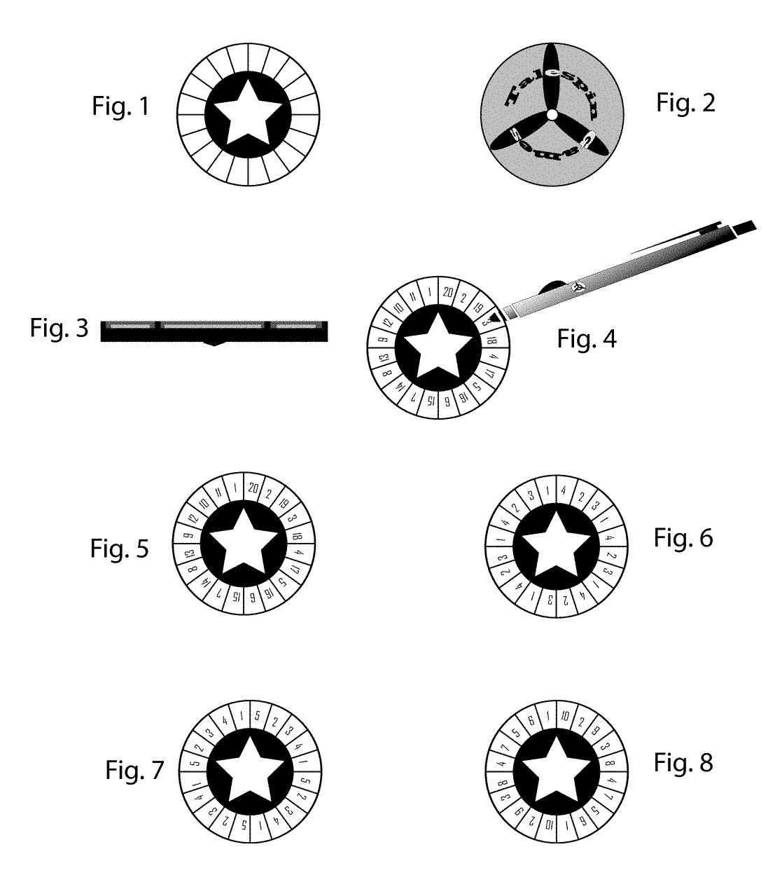

In reference to FIG. 4, which shows the proper operation of the device. First the device is set rotating on its spinning point. Number generation is achieved via stopping the coin's rotation by catching the tip of a pointer such as a pen or pencil in the slots on the obverse.

Coin 24 includes an obverse side with indented slots and reverse side with a spinning point which extends slightly beyond the flat plain of a normal coin.

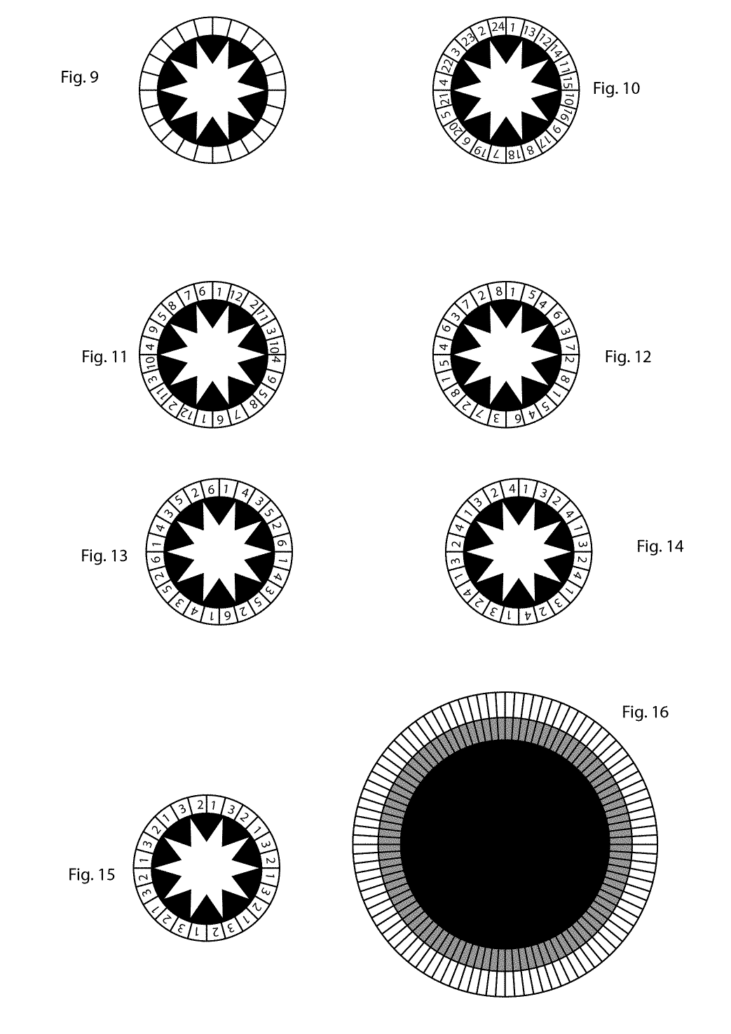

In reference to FIGS. 9-15, preferably, each of the slots is configured and arranged to display clear, readable indicia. In particular the shape of each of the slots is advantageous because of their ability to display large, legible indicia while also maintaining the ability to have artwork put onto the coin's surface. While a variety of working embodiments are contemplated, in the illustrated embodiments, the slots have a tapered appearance, and are not rectangular. In other words, each of the slots are bound by an outer and inner periphery, which consists of tapered slices, with an inner circle for artwork display.

Each of the slots, is identically shaped to every other slot, apart from possible stamped or die struck indicia.

Again in reference to FIGS. 2-3 the spinning point is illustrated. Coin 24 is constructed such that the center of mass of the coin is centered over the precise center of the spinning point. By center of the spinning point, it is meant a point that is centered over the physical spinning point on the reverse side of the coin.

In reference to FIG. 16, Preferably, each of the slots is configured and arranged to display clear, readable indicia. In particular the shape of each of the slots is advantageous because of their ability to display large, legible indicia while also maintaining the ability to have artwork put onto the coin's surface. While a variety of working embodiments are contemplated, in the illustrated embodiments, the slots have a tapered appearance, and are not rectangular. In other words, each of the slots are bound by an outer and inner periphery, which consists of tapered slices, with a filled inner circle for artwork display.

Each of the slots, is identically shaped to every other slot, apart from possible stamped or die struck indicia.

In reference now to FIG. 16 the spinning point is illustrated. Coin 100 is constructed such that the center of mass of the coin is centered over the precise center of the spinning point. By center of the spinning point, it is meant a point that is centered over the physical spinning point on the reverse side of the coin.

Other embodiments of the invention will be apparent to those skilled in the art from consideration of the specification and practice of the invention disclosed herein. In particular, one skilled in the art will understand that coin constructions having slots with most multiples can be constructed according to the principles taught herein.

1. A coin construction comprising:
(a) an obverse side with artwork
(b) said obverse side having a number of discrete slots
(c) each of said slots identically shaped and having equal surface areas
(d) a reverse side with a raised spinning point

2. A die construction according to claim 1, wherein:
(a) each of said slots include stamped and painted indicia thereon.

3. A die construction according to claim 2, wherein:
(a) each of said slots is tapered.

4. A die construction according to claim 3, wherein:
(a) said number of slots is twenty-four
(b) said indicia range from one to three, one to four, one to six, one to eight, one to twelve, or one to twenty-four

5. A die construction according to claim 3, wherein:
(a) said number of slots is twenty
(a) said indicia range from one to three, one to 4, one to five, one to ten, or one to twenty

6. A die construction according to claim 3, wherein:
(a) said number of slots is one hundred
(b) said indicia range from one to one hundred
